(19) United States
(12) Patent Application Publication
(10) Pub. No.: US 2026/0217376 A1
(43) Pub. Date: Jul. 30, 2026

(54) METHOD AND SYSTEM FOR ASSISTING WITH THE PILOTING OF A ROTARY WING AIRCRAFT IN A FUEL ECONOMY MODE

(71) Applicant: SAFRAN HELICOPTER ENGINES, Bordes (FR)

(72) Inventors: Vincent Thomas RETOIN, Moissy-Cramayel (FR); Alexandre Edouard Emile FIGIELSKI, Moissy-Cramayel (FR); Quentin VINCENZOTTO, Moissy-Cramayel (FR); Sébastien Alexis Matthieu CARLES, Moissy-Cramayel (FR)

(73) Assignee: SAFRAN HELICOPTER ENGINES, Bordes (FR)

(21) Appl. No.: 19/151,920

(22) PCT Filed: Feb. 1, 2024
(86) PCT No.: PCT/FR2024/050133

§ 371 Date: Jul. 29, 2025

(30) Foreign Application Priority Data
Feb. 1, 2023 (FR) FR2300935

(51) Int. Cl. B64D 31/12; B64C 27/12; B64D 31/09

(52) U.S. Cl. CPC B64D 31/12; B64C 27/12; B64D 31/09

(57) ABSTRACT

A system for assisting the piloting of a rotary-wing aircraft, including two engines, a first engine of which is put in standby to ensure the operation of the aircraft in a fuel economy mode, the so-called ECO mode, the second engine remaining active in the ECO mode, a system in which, to allow the activation by a pilot of the ECO mode, a flight computer is configured to check, in real time, the fulfilment of the following conditions for authorization of entry into ECO mode: the sum of the powers supplied by the engines is less than a maximum continuous power, the rotation speed N2 of a power turbine of the second engine is greater than a determined speed threshold which is between 80% and 90% of the maximum speed of the engine.

### TECHNICAL FIELD

This invention relates to the field of assistance with the control of rotary-wing aircraft, particularly helicopters or drones, and more specifically refers to a fuel economy mode or “ECO mode” consisting in putting one of the two engines of a twin-engine aircraft, for example in standby mode during cruise or holding flight and search phases (loitering) in order to save fuel.

### PRIOR ART

Climate change is a major preoccupation for many legislative and regulatory bodies throughout the world. Specifically, various restrictions on carbon emissions have been, are being or will be adopted by various States. In particular, an ambitious standard is applicable to both new types of airplane and also to those currently in circulation, requiring the implementation of technological solutions to render them compliant with the regulations in effect. In recent years civil aviation has been committed to making a contribution to the combat against climate change.

Technological research has already enabled a very significant improvement in the environmental performance of airplanes. The Applicant takes into consideration the factors affecting all the phases of design and development to obtain components and aeronautical products which consume less energy, are more environmentally-friendly and can be integrated and used in civil aviation with only moderate environmental impacts, in the aim of improving the energy efficiency of airplanes. As a consequence, the Applicant is constantly working to reduce its climate impact by the use of methods and the exploitation of development and manufacturing processes which are virtuous and keep greenhouse gas emissions to a minimum to reduce the environmental footprint of its activity.

This sustained research and development effort simultaneously concerns the new generations of airplane engines, the lightening of aircraft, particularly via the materials used and lighter onboard equipment, the development of the use of electrical technology to provide propulsion, and finally aeronautical biofuels.

In this context, it is known for twin-engine aircraft to resort to using the engines in a fuel economy mode, the so-called ECO mode, whether it be done with the combustion chamber of the engine on or off, during cruise or loitering phases. In such a mode, used for example in rotary-wing twin-engine aircraft, one of the engines of the aircraft is put in standby mode.

However, when incorrectly used, this operating mode can cause premature wear to the engine supplying the propulsion power of the aircraft, particularly for the hot parts of the gas turbine, a phenomenon known as endocreep.

For safety reasons, authorization then maintenance of the ECO mode are necessary and involve carrying out a safety test (or Safety Check) to determine the value of the engine parameters and then check whether or not these engine parameters are in appropriate operating ranges to engage then maintain the ECO mode.

However, carrying out such a safety check takes a certain amount of time and thus proves particularly restrictive for the pilot, who must then maneuver the aircraft to stabilize the ratings and thermal management of the engine.

### SUMMARY OF THE INVENTION

This invention thus has as subject a method for assisting piloting that palliates the aforementioned drawbacks and allows for optimal use of the ECO mode so as to save fuel. The invention also aims to ensure that the ECO mode can be used in complete safety.

These aims are achieved by a method for assisting the piloting of a rotary-wing aircraft, including two engines, a first engine of which is put in standby to ensure the operation of the aircraft in a fuel economy mode, the so-called ECO mode, the second engine remaining active in said ECO mode, the method being characterized in that to allow the activation by a pilot of the ECO mode, a flight computer of the aircraft checks, in real time, the fulfilment of the following conditions for authorization of entry into ECO mode: the sum of the powers supplied by the engines is less than a maximum continuous power, the rotation speed N2 of a power turbine of the second engine is greater than a determined speed threshold, the altitude of the aircraft is greater than a minimum value allowing a transient phase of autorotation during the reactivation of the engine in standby in the event of a fault of the active engine, and no detected critical fault exists.

Similarly, to allow the reactivation of the first engine and therefore to exit ECO mode, at least one of the preceding conditions for entry into ECO mode or one of the following additional conditions must be false: no acceleration limit is reached, the oil temperature TH is greater than a determined temperature threshold making it possible to ensure the rapid reactivation of the engine in standby, the fuel temperature Tcarb is greater than a determined temperature threshold making it possible to ensure the rapid reactivation of the engine in standby, and there is no loss of power to the active engine.

Thus, the value of the ratings and the margins of the engine parameters in the event of activation of ECO mode are estimated directly based on the engine model implemented in the flight computer, and both their updating and display can thus be done more regularly and in a way that is more transparent for the pilot.

Preferably, the critical faults comprise data faults which impede the proper operation of the engine and/or its equipment, serial connection faults, electrical system faults, faults causing the loss of engine control, control system faults, and hydraulic system faults.

Advantageously, the fulfilment or non-fulfilment of the authorization conditions is displayed on an indicator dial including three power ranges respectively corresponding to the fulfilment of the authorization conditions, to the possible fulfilment of the authorization conditions and to the non-fulfilment of the authorization conditions.

Preferably, the rotation speed N2 of the power turbine is greater than a threshold between 80% and 90% of the maximum speed of the engine, the oil or fuel temperature threshold is of 5° C. and the minimum value of the minimum altitude is equal to 300 m.

The invention also relates to the system for assisting piloting implementing the aforementioned method, as well as an aircraft, preferably a twin-engine helicopter, implementing such a system for assisting piloting.

### BRIEF DESCRIPTION OF THE DRAWINGS

Other features and advantages of this invention will become apparent from the description given below, with reference to the single figure which illustrates an exemplary embodiment thereof without any limitation, and in which:

FIG. 1 schematically illustrates an aircraft comprising a system for assisting piloting in ECO mode according to an example of the invention.

### DESCRIPTION OF THE EMBODIMENTS

The principle of the invention is based on the determination, in real time by the flight computer of the aircraft, of different parameters which are then synthesized to make available to the pilot on a screen of the aircraft cockpit (for example the FLI for First Limit Indicator) a flight control indication indicating to him whether or not entry into fuel economy mode (ECO mode) is authorized. Preferably, the pilot can also have access to indicators to know whether or not the maintenance of this ECO mode is authorized, once said mode is activated.

For example, if the duration of the cruise phase is sufficient, typically at least greater than 10 minutes, and the power requested during this phase is not too high (corresponding to an engine control temperature greater than 1400K) then the pilot can engage ECO mode on the condition that the authorization conditions defined by the flight computer are all met.

To do this, with all engines operational and conventionally controlled based on their nominal speed and/or torque setpoint, it is advisable for the flight parameters to meet the following authorization conditions to allow activation of the ECO mode:

the sum P of the powers supplied by the engines is less than the maximum continuous power (PMC),
the rotation speed N2 of the power turbine of the active engine is greater than a determined speed threshold (preferably corresponding to a threshold between 80% and 90% of the maximum speed of the engine),
the altitude of the aircraft H is greater than a minimum value allowing a transient phase of autorotation during the reactivation of the engine in standby in the event of a fault of the active engine (safety criterion), typically Alt>300 m, and
no detected critical fault exists (nonPa). The term “critical faults” should be understood to mean the faults of certain data (NR i.e. rotation speed of the rotor, selector, fuel pressure) which impede the proper operation and/or of its equipment, serial connection faults (inter-computer and computer-to-aircraft) electrical system faults, IGV faults, faults able to cause effects on the control system (limited acceleration/deceleration speed), hydraulic system faults and any other fault causing the loss of engine control.

Having a rotation speed N2 greater than a threshold that is between 80% and 90% of the maximum speed of the engine makes it possible to encompass the cruise or holding flight phases and the taxiing and ground idle phases of the aircraft.

In other words, a speed of rotation N2 greater than 80% of the maximum speed of the engine makes it possible to ensure the operation of the aircraft in a fuel economy mode, the so-called ECO mode, in a taxiing and ground idle phase.

Similarly, a speed of rotation N2 greater than 90% of the maximum speed of the engine makes it possible to ensure the operation of the aircraft in a fuel economy mode, the so-called ECO mode, in a cruise phase. These conditions for authorization of entry into ECO mode must be met cumulatively for activation of the ECO mode to be allowed. For entry into ECO mode, the computer of the engine to be put in standby preferably performs several checks. The first consists in checking that the authorization of the avionic systems has been received.

The computer also performs consistency checks to check that the request for entry into ECO mode has been properly formulated and avoid the untimely activation of ECO mode. The computer also checks the absence of one or more critical faults. These faults for example comprise: faults that may affect the operation of the ECO mode, the operation of the engines, or the operation of the system for reactivation of the engine that is to be put in standby.

Once all these checks have been performed and only if the conditions are met, the first engine preferably changes into ECO mode gradually. On entering ECO mode, the power of the first engine is preferably reduced gradually until a minimum power is reached. The operation of the first engine at minimum power is maintained for a time interval, for example between 1 and 2 minutes. Next, the engine starter is activated to check the operation of the ECO mode. If the latter is operating correctly, the first engine is then put in standby.

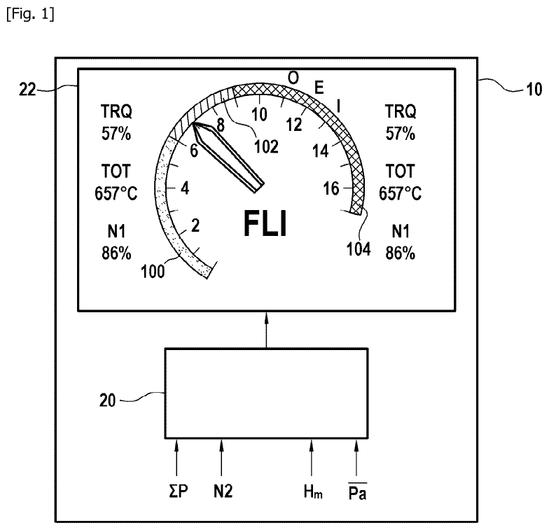

As illustrated in FIG. 1, in an aircraft 10, when all the engines are operational and controlled at their nominal setpoint, the flight computer 20 can compute the power that should be supplied by the engine that would remain active in ECO mode (estimated ECO power). Furthermore, by adding the power supplied by each engine and using an engine model installed in the flight computer, it is possible to determine what would be the engine parameters (N1, TC and torque) corresponding to this power and the level of damage to the engine remaining active.

In particular, the engine model implemented in the computer is used to evaluate in real time the state of health of the second engine remaining active and to determine in real time whether or not the second engine remaining active in ECO mode is capable of supplying the necessary power to continue the flight.

All these data can be used to determine whether or not entry into ECO mode is permitted and whether or not this ECO is advised. They may also be displayed (constantly or on request, in the first limit indicator dial 22 for example) in the aim of assisting the pilot to position himself in the power range 100 the most appropriate to ECO mode for example (the following ranges respectively illustrating a power range 102 that is optionally possible and a prohibited power range 104). The pilot thus has access to a provisional view of the engine parameters if the ECO mode was activated. He can thus anticipate the margin of available power with respect to the maximum available power in ECO mode and the fuel consumption savings with respect to operation with all engines. This indicator can be associated with several parameters (N1, TC, torque, power etc.).

In the same way, when the ECO mode is active, the engines and the whole electrical system dedicated to the reactivation of the engine in standby are monitored in such a way as to start the reactivation of the engine in standby if this proves necessary. The flight computer can thus constantly perform a monitoring of the entire state of the engines and of the electrical system, and can in particular determine in real time whether or not conditions of maintenance in ECO mode are all met. If a fault or a loss of power of the active engine is detected, the engine in standby is then reactivated.

Note that the preceding authorization to enter ECO mode is not necessarily subject to the same conditions, and is therefore not necessarily computed in the same way, as the authorization to stay in ECO mode (or any request to exit ECO mode). For example, the engine in standby will be reactivated (therefore causing exit from ECO mode) if at least one of the following conditions for maintaining ECO mode becomes false, namely:
the power supplied by the active engine is less than a maximum determined power, typically the PMC,
the speed of rotation N2 of the power turbine of the active engine is greater than a determined speed threshold,
the altitude H is greater than a minimum value allowing a transient phase of autorotation during the reactivation of the engine in standby in the event of a fault of the active engine (safety criterion), typically Alt>300 m,
no detected critical fault exists (nonPa),
no acceleration limit has been reached, these acceleration limits being essentially a surge protection limit, a limit of acceleration of the gas generator, or a fuel flow rate greater than or equal to a maximum flow rate, typically 500 kg/h.
the oil temperature Th is greater than a determined temperature threshold making it possible to ensure rapid reactivation of the engine in standby, typically Th>5° C.,
the fuel temperature Tcarb is greater than a determined temperature threshold making it possible to ensure rapid reactivation of the engine in standby, typically Tcarb>5° C., and
there is no loss of power of the active engine.

When the aircraft is in ECO mode and a fault is detected, if the detected fault prevents or runs the risk of freezing proper operation of the ECO mode, the engine put in ECO mode will exit ECO mode. This type of fault is considered critical to the operation of the ECO mode. Thus, the criticality of the fault or faults has an effect on the exit from ECO mode. The presence of a single fault preventing the correct operation of the ECO mode triggers the exit from ECO mode.

However, if the detected fault does not affect or does not risk affecting the operation of the ECO mode, or the power availability of the engine remaining active, the ECO mode is preferably maintained. For example, in the presence of a fault in the flight recorder system, this will not constitute an obstacle to continuing in ECO mode. On the other hand, if a fault is present in the system for measuring the speed of rotation of a power turbine of the active engine, the ECO mode will preferably not be kept on, and one will not wait for the presence of a new fault to exit ECO mode. This is because a single fault can cause damage to the engine remaining active.

Note also that several indications relating to the ECO mode can be issued in such a way as to inform the pilot about the use of the ECO mode (ECO mode active, ECO mode authorized, ECO mode interrupted), such as indications relating to a transition to the standby phase; and/or to an engine in standby; and/or to a reactivation in progress (and the type of reactivation); and/or to an interruption of the reactivation.

Note that while reference has been made mainly to conventional twin-engine applications, the invention naturally has an application to both multiple engines and drones, in which a recommendation for use of the engines could also be made to the pilot or to the flight control system.

1. A method for assisting the piloting of a rotary-wing aircraft, including two engines, a first engine of which is put in standby to ensure the operation of the aircraft in a fuel economy mode, the so-called ECO mode, the second engine remaining active in said ECO mode,
the method being characterized in that to allow the activation by a pilot of the ECO mode, a flight computer of the aircraft checks, in real time, the fulfilment of the following conditions for authorization of entry into ECO mode:
the sum of the powers supplied by the engines is less than a maximum continuous power,
the rotation speed N2 of a power turbine of the second engine is greater than a determined speed threshold which is between 80% and 90% of the maximum speed of the engine,
the altitude of the aircraft is greater than a minimum value allowing a transient phase of autorotation during the reactivation of the engine in standby in the event of a fault of the active engine,
and no detected critical fault exists.

2. The method as claimed in claim 1, wherein, to allow the reactivation of the first engine and therefore to exit the ECO mode, at least one of the preceding conditions for entry into ECO mode or one of the following additional conditions must be false:
no acceleration limit is reached,
the oil temperature TH is greater than a determined temperature threshold making it possible to ensure the rapid reactivation of the engine in standby,
the fuel temperature Tcarb is greater than a determined temperature threshold making it possible to ensure the rapid reactivation of the engine in standby,
and there is no loss of power to the active engine.

3. The method as claimed in claim 2, wherein the oil or fuel temperature threshold is of 5° C.

4. The method as claimed in claim 1, wherein the critical faults comprise data faults which impede the proper operation of the engine and/or its equipment, serial connection faults, electrical system faults, faults causing the loss of engine control, control system faults, and hydraulic system faults.

5. The method as claimed in claim 1, wherein the fulfilment or non-fulfilment of the authorization conditions is displayed on an indicator dial including three power ranges respectively corresponding to the fulfilment of the authorization conditions, to the possible fulfilment of the authorization conditions and to the non-fulfilment of the authorization conditions.

6. The method as claimed in claim 1, wherein the minimum value of the altitude is equal to 300 m.

7. A system for assisting the piloting of a rotary-wing aircraft, including two engines, a first engine of which is put in standby to ensure the operation of the aircraft in a fuel economy mode, the so-called ECO mode, the second engine remaining active in said ECO mode, the method being wherein to allow the activation by a pilot of the ECO mode, it comprises a flight computer configured to check, in real time, the fulfilment of the following conditions for authorization of entry into ECO mode: the sum of the powers supplied by the engines is less than a maximum continuous power, the rotation speed N2 of a power turbine of the second engine is greater than a determined speed threshold which is between 80% and 90% of the maximum speed of the engine, the altitude of the aircraft is greater than a minimum value allowing a transient phase of autorotation during the reactivation of the engine in standby in the event of a fault of the active engine, and no detected critical fault exists.

8. The system as claimed in claim 7, further comprising an indicator dial connected to the flight computer and configured to display in three power ranges respectively corresponding to the fulfilment of the authorization conditions, to the possible fulfilment of the authorization conditions and to the non-fulfilment of the authorization conditions.

9. An aircraft, preferably a twin-engine helicopter, comprising a system for assisting piloting as claimed in claim 7.
